(19) United States
(12) Patent Application Publication
(10) Pub. No.: US 2011/0007257 A1
(43) Pub. Date: Jan. 13, 2011

(54) Liquid crystal display

(76) Inventors: Woongki Min, Buk-gu (KR); Hongsung Song, Gumi-si (KR)

Correspondence Address: MCKENNA LONG & ALDRIDGE LLP, 1900 K STREET, NW, WASHINGTON, DC, 20006, US

(21) Appl. No.: 12/591,219

(22) Filed: Nov. 12, 2009

(30) Foreign Application Priority Data
Jul. 10, 2009 (KR) 10-2009-0063112

(51) Int. Cl. G02F 1/1345

(52) U.S. Cl. 349/150

(57) ABSTRACT

A liquid crystal display is disclosed. The liquid crystal display includes a liquid crystal display panel including a pixel array in which data lines and gate lines cross each other, liquid crystal cells are arranged in a matrix format according to a crossing structure of the data lines and the gate lines, and thin film transistors (TFTs) are alternately connected to data lines adjacent to the TFTs in zigzag form, a plurality of source driver integrated circuits (ICs), each of which supplies a data voltage to the data lines, and a gate drive circuit that sequentially supplies a gate pulse to the gate lines.

This application claims the benefit of Korea Patent Application No. 10-2009-0063112 filed on Jul. 10, 2009, the entire contents of which is incorporated herein by reference for all purposes as if fully set forth herein.

### BACKGROUND OF THE INVENTION

1. Field of the Invention

Embodiments of the invention relate to a liquid crystal display driving a liquid crystal display panel in a dot inversion manner using a source driver integrated circuit (IC) outputting a data voltage whose a polarity is inverted in a column inversion manner.

2. Discussion of the Related Art

Active matrix type liquid crystal displays display a moving picture using a thin film transistor (TFT) as a switching element. The active matrix type liquid crystal displays have been implemented in televisions as well as display devices in portable devices, such as office equipment and computers, because of the thin profile of an active matrix type liquid crystal displays. Accordingly, cathode ray tubes (CRT) are being rapidly replaced by active matrix type liquid crystal displays.

A liquid crystal display generally includes a liquid crystal display panel, a backlight unit providing light to the liquid crystal display panel, source driver integrated circuits (ICs). supplying a data voltage to data lines of the liquid crystal display panel, gate driver ICs supplying a gate pulse (i.e., a scan pulse) to gate lines (i.e., scan lines) of the liquid crystal display panel, a control circuit controlling the source driver ICs and the gate driver ICs, a light source driving circuit driving a light source of the backlight unit, and the like.

Examples of a liquid crystal display driving liquid crystal cells in a dot inversion manner using source driver ICs driven in a column inversion manner by zigzag connecting TFTs of a pixel array arranged along in a column direction (or a vertical line direction) to data lines adjacent to the TFTs are disclosed in Korea Patent Application Nos. 10-2002-0021792 (Apr. 20, 2002), 10-2002-0021795 (Apr. 20, 2002), and 10-2002-0070305 (Nov. 13, 2002) corresponding to the present applicant, and which are hereby incorporated by reference in their entirety. A heat generation amount and power consumption of the source driver ICs can be reduced because a polarity of a data voltage supplied to the data lines of the liquid crystal display panel through output channels of the source driver ICs remains in the same state during 1 frame period. Further, a flicker can be minimized by inverting the polarity of the data voltage, to which liquid crystal cells will be charged, in a dot inversion manner. Dummy liquid crystal cells exist at an edge of a liquid crystal display panel of the liquid crystal display disclosed in the above patent applications. The dummy liquid crystal cells are separated from the data lines and receive dummy data. However, it is difficult to achieve a circuit supplying the data voltage to the dummy liquid crystal cells. If the dummy liquid crystal cells are separated from the data lines, data cannot be displayed to an edge of the pixel array. Accordingly, a display surface of the pixel array is not efficiently used.

### SUMMARY OF THE INVENTION

Embodiments of the invention provide a liquid crystal display capable of driving a liquid crystal display panel in a dot inversion manner using a source driver integrated circuit (IC) outputting a data voltage, whose a polarity is inverted in a column inversion manner, and capable of stably supplying the data voltage to liquid crystal cells existing at an edge of the liquid crystal display panel.

In one aspect, there is a liquid crystal display comprising a liquid crystal display panel including a pixel array in which data lines and gate lines cross each other, liquid crystal cells are arranged in a matrix format according to a crossing structure of the data lines and the gate lines, and thin film transistors (TFTs) are alternately connected to data lines adjacent to the TFTs in zigzag form, a plurality of source driver integrated circuits (ICs), each of which supplies a data voltage to the data lines, and a gate drive circuit that sequentially supplies a gate pulse to the gate lines.

The data voltage may be supplied through a first data line positioned at an end of one side of the pixel array to liquid crystal cells positioned at an end of the other side of the pixel array.

The data voltage output from a first source driver IC positioned at one side of the liquid crystal display panel may be supplied to a first data line positioned at an end of one side of the pixel array.

The data voltage output from a second source driver IC positioned at the other side of the liquid crystal display panel may be supplied to a second data line positioned at an end of the other side of the pixel array.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a block diagram illustrating a liquid crystal display according to a first embodiment of the invention;

FIG. 2 illustrates a first embodiment of a pixel array;

FIG. 3 is a waveform diagram illustrating a data voltage supplied to data lines shown in FIG. 2;

FIG. 4 illustrates a second embodiment of a pixel array;

FIG. 5 is a waveform diagram illustrating a data voltage supplied to data lines shown in FIG. 4;

FIG. 6 is a block diagram illustrating a liquid crystal display according to a second embodiment of the invention;

FIG. 7 is a plane view showing a first data line and a dummy data line connected through a connection line;

FIG. 8 is a cross-sectional view showing a connection portion between a first data line and a connection line taken along line I-I′ of FIG. 7;

FIG. 9 is a block diagram illustrating a liquid crystal display according to a third embodiment of the invention;

FIG. 10 is a block diagram illustrating a liquid crystal display according to a fourth embodiment of the invention;

FIG. 11 is a block diagram illustrating a liquid crystal display according to a fifth embodiment of the invention;

FIG. 12 is a block diagram illustrating a liquid crystal display according to a sixth embodiment of the invention; and

FIG. 13 is a waveform diagram showing a data voltage supplied to data lines of FIG. 12.

### DETAILED DESCRIPTION OF THE EMBODIMENTS

Reference will now be made in detail embodiments of the invention examples of which are illustrated in the accompanying drawings.

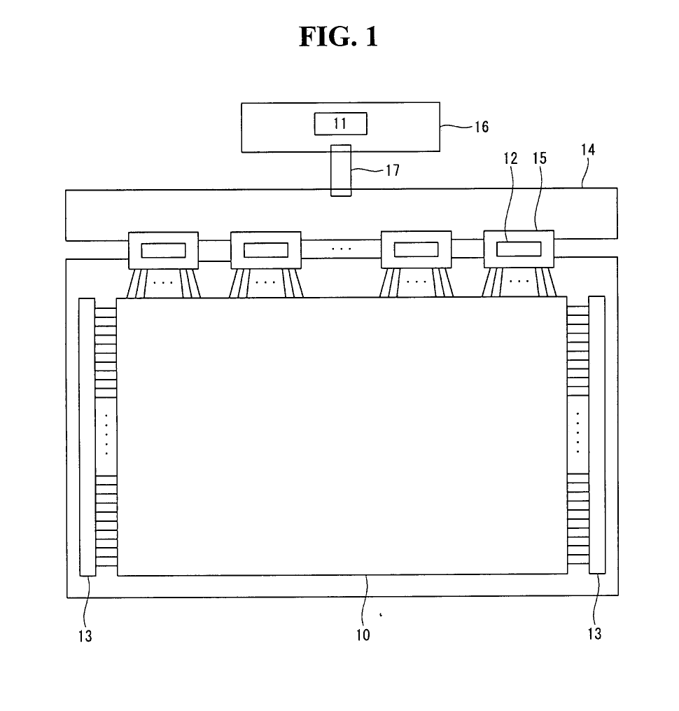

As shown in FIG. 1, a liquid crystal display according to a first embodiment of the invention includes a liquid crystal display panel on which a pixel array 10 is formed, source driver integrated circuits (ICs) 12, a gate drive circuit 13, and a timing controller 11. In addition, a backlight unit may underlie the liquid crystal display panel.

The liquid crystal display panel on which the pixel array 10 is formed includes an upper glass substrate and a lower glass substrate that are positioned opposite each other with a liquid crystal layer interposed between the upper glass substrate and the lower glass substrate. The pixel array 10 includes liquid crystal cells arranged in a matrix format according to a crossing structure of data lines and gate lines of the liquid crystal display panel to display video data. The pixel array 10 includes a thin film transistor (TFT) formed at each of crossings of the data lines and the gate lines and pixel electrodes connected to the TFTs. The TFTs of the pixel array 10 are zigzag connected to data lines adjacent to the TFTs when viewed in a column direction. The liquid crystal display panel displays an image of the video data through a control of a transmitted amount of light by driving each of the liquid crystal cells of the pixel array 10 by a difference between a data voltage applied to the pixel electrodes through the TFTs and a common voltage applied to a common electrode through the TFT.

A black matrix, a color filter, and a common electrode are formed on the upper glass substrate of the liquid crystal display panel. The common electrode is formed on the upper glass substrate in a vertical electric field driving manner, such as a twisted nematic (TN) mode and a vertical alignment (VA) mode. The common electrode and the pixel electrode are formed on the lower glass substrate in a horizontal electric field driving manner, such as an in-plane switching (IPS) mode and a fringe field switching (FFS) mode.

Polarizing plates are respectively attached to the upper and lower glass substrates of the liquid crystal display panel. Alignment layers for setting a pre-tilt angle of liquid crystals are respectively formed on the upper and lower glass substrates.

The liquid crystal display panel applicable to the embodiment of the invention may be implemented in any liquid crystal mode as well as the TN, VA, IPS, and FFS modes. The liquid crystal display according to the embodiment of the invention may be implemented in any type liquid crystal display including a backlit liquid crystal display, a transflective liquid crystal display, and a reflective liquid crystal display. A backlight unit is necessary in the backlit liquid crystal display and the transflective liquid crystal display. The backlight unit may be implemented as a direct type backlight unit or an edge type backlight unit.

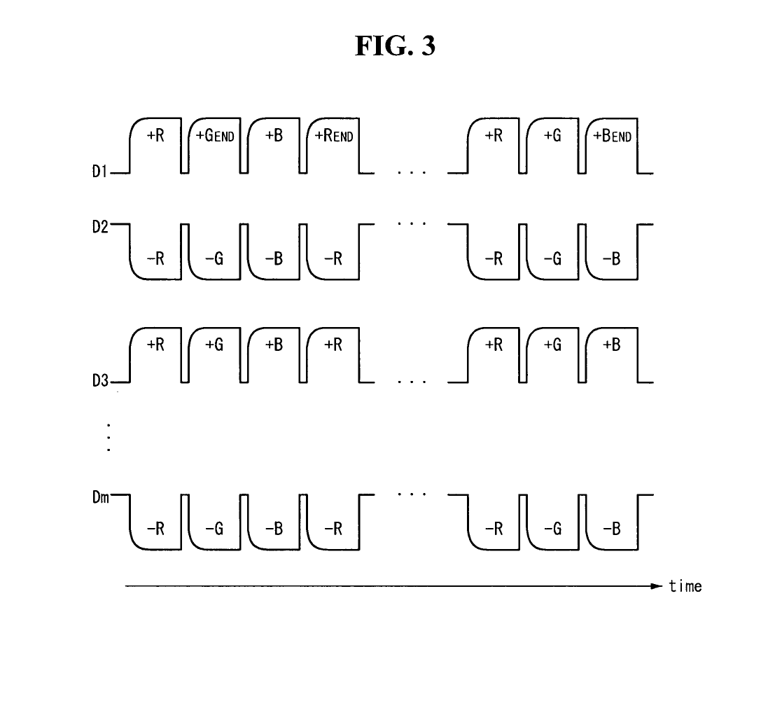

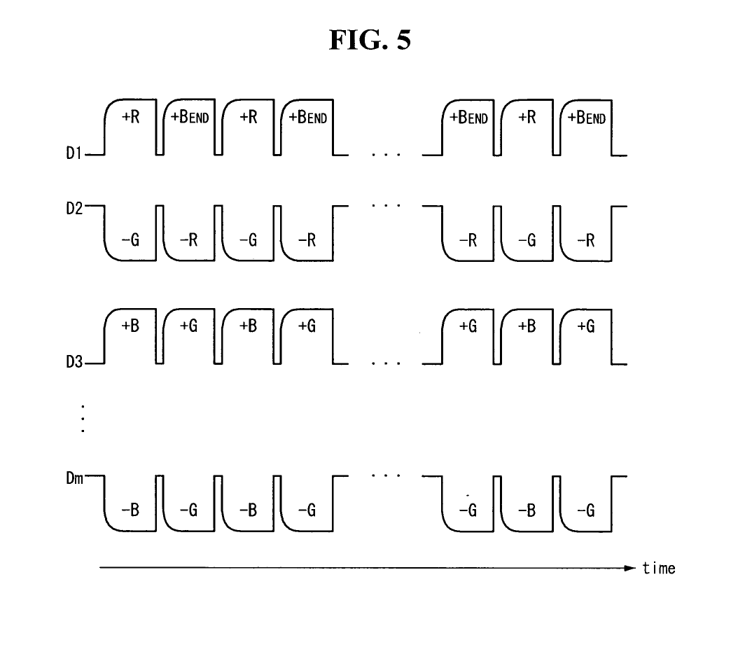

Each of the source driver ICs 12 is mounted on a tape carrier package (TCP) 15. The source driver ICs 12 mounted on the TCP 15 are attached to the lower glass substrate of the liquid crystal display panel through a tape automated bonding (TAB) process and are connected to a source printed circuit board (PCB) 14. The source driver ICs 12 may be attached to the lower glass substrate of the liquid crystal display panel through a chip on glass (COG) process. Data output channels of the source driver ICs 12 are connected one-to-one to the data lines of the pixel array 10. Each of the source driver ICs 12 receives digital video data from the timing controller 11. The source driver ICs 12 convert the digital video data into a positive or negative analog data voltage in response to a source timing control signal received from the timing controller 11 to supply the positive/negative analog data voltage to the data lines of the pixel array 10 through the data output channels. The source driver ICs 12 supply the data voltages of opposite polarities to adjacent data lines under the control of the timing controller 11 and allows a polarity of the data voltage supplied to each data line to remain in the same state during 1 frame period. Accordingly, the source driver ICs 12 output the data voltage whose the polarity is inverted in a column inversion manner as shown in FIGS. 3 and 5.

The gate drive circuit 13 sequentially supplies a gate pulse to the gate lines of the pixel array 10 in response to a gate timing control signal received from the timing controller 11. The gate drive circuit 13 may be mounted on a TCP. The gate drive circuit 13 mounted on the TCP may be attached to the lower glass substrate of the liquid crystal display panel through a TAB process or may be directly formed on the lower glass substrate through a Gate In Panel (GIP) process at the same time as the forming of the pixel array 10. The gate drive circuit 13 may be positioned at both sides of the pixel array 10 as shown in FIG. 1 or at one side of the pixel array 10.

The timing controller 11 supplies the digital video data received from an external system board to the source driver ICs 12. The timing controller 11 generates the source timing control signal for controlling operation timing of the source driver ICs 12 and the gate timing control signal for controlling operation timing of the gate drive circuit 13. The timing controller 11 is mounted on a control PCB 16. The control PCB 16 is connected to the source PCB 14 using a flexible circuit board 17, such as a flexible printed circuit board (FPCB) and a flexible flat cable (FFC).

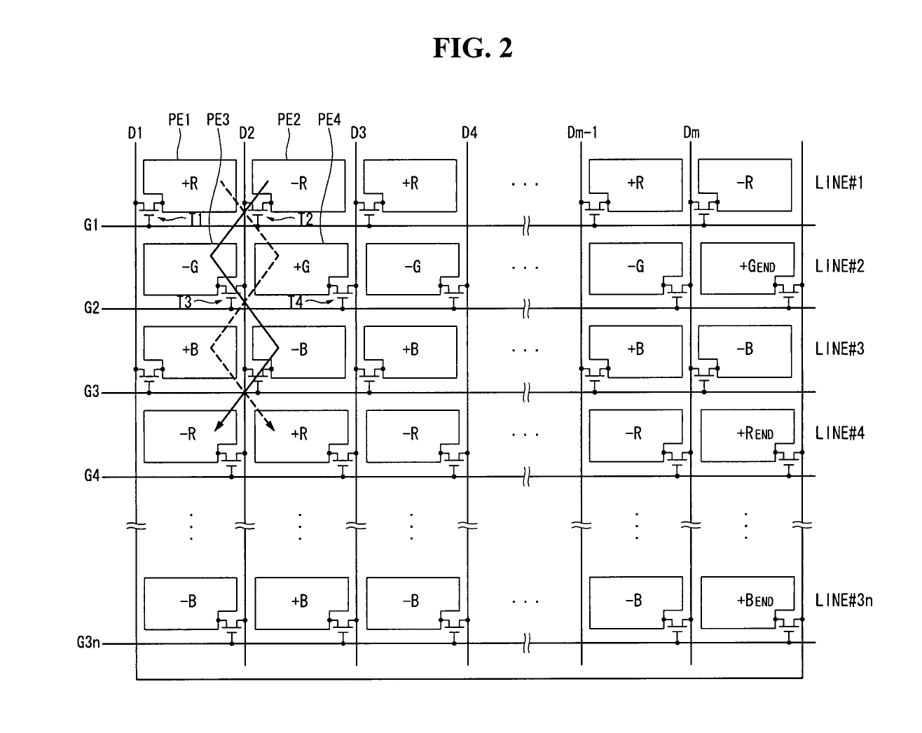

FIG. 2 is an equivalent circuit diagram illustrating a first embodiment of the pixel array 10.

As shown in FIG. 2, the pixel array 10 includes m data lines D1 to Dm (where m is a positive integer) and 3n gate lines G1 to G3n (where n is a positive integer) crossing each other at a resolution of m×n, a plurality of pixel electrodes PE1 to PE4 positioned in a matrix format, and a plurality of TFTs T1 to T4 respectively connected to the pixel electrodes PE1 to PE4. Liquid crystal cells of a red subpixel R are positioned on (3i+1)th (where i is a positive integer including zero) horizontal lines LINE#1, LINE#4, . . . of the pixel array 10. Liquid crystal cells of a green subpixel G are positioned on (3i+2)th horizontal lines LINE#2 , LINE#5, . . . of the pixel array 10. Liquid crystal cells of a blue subpixel B are positioned on (3i+3)th horizontal lines LINE#3, LINE#6, . . . , LINE#3n of the pixel array 10. The red subpixel R, the green subpixel G, and the blue subpixel B are positioned on each of columns of the pixel array 10 along a direction of a vertical line in the order named. Each of the TFTs T1 to T4 supplies the data voltage from the data lines D1 to Dm to the pixel electrodes PE1 to PE4 in response to a gate pulse from the gate lines G1 to G3n. The TFTs in each of the columns of the pixel array 10 are alternately connected to the two adjacent data lines at left and right sides of the TFTs in zigzag form. For example, in the TFTs between the adjacent data lines D1 and D2, the TFT T1 is connected to the right side of the data line D1, and the TFT T3 is connected to the right side of the data line D2. The data voltages of the same polarity and the data voltages of opposite polarities are supplied to adjacent liquid crystal cells in vertical and horizontal directions during 1 frame period as indicated by the dotted line and the solid line of FIG. 2 because of such an arrangement of the TFTs. Accordingly, a polarity pattern of the data voltages charged to the liquid crystal cells is implemented according to a dot inversion scheme.

The TFTs T1 and T2 for connecting the pixel electrodes PE1 and PE2 positioned at right side of each of the data lines D1 to Dm to the data lines D1 to Dm are positioned on odd-numbered lines LINE#1, LINE#3, . . . L1NE#3n−1. In the first TFT T1, a drain electrode is connected to the first data line D1, a source electrode is connected to the first pixel electrode PE1 positioned at right side of the first data line D1, and a gate electrode is connected to the first gate line G1. In the second TFT T2, a drain electrode is connected to the second data line D2, a source electrode is connected to the second pixel electrode PE2 positioned at right side of the second data line D2, and a gate electrode is connected to the first gate line G1.

Further, the TFTs T3 and T4 for connecting the pixel electrodes PE3 and PE4 positioned at left side of each of the data lines D2 to Dm to the data lines D2 to Dm are positioned on even-numbered lines LINE#2, L1NE#4, . . . LINE#3n. In the third TFT T3, a drain electrode is connected to the second data line D2, a source electrode is connected to the third pixel electrode PE3 positioned at left side of the second data line D2, and a gate electrode is connected to the second gate line G2. In the fourth TFT T4, a drain electrode is connected to the third data line D3, a source electrode is connected to the fourth pixel electrode PE4 positioned at left side of the third data line D3, and a gate electrode is connected to the second gate line G2.

The TFTs positioned at right end of the even-numbered lines LINE#2, LINE#4, . . . , LINE#3n are referred to as an end TFT. The end TFTs are connected to the first data line D1 and supply the data voltage supplied through the first data line D1 to the pixel electrodes R_{END}, G_{END}, and B_{END} (hereinafter, referred to as an end pixel electrode) positioned at right end of the even-numbered lines LINE#2, LINE#4, . . . , L1NE#3n. A data pad connected to the first data line D1 is connected to an output terminal of the source driver IC 12 in a left upper portion of the liquid crystal display panel. The first data line D1 extends from a left end of the pixel array 10 to a right end of the pixel array 10 across a lower portion of the liquid crystal display panel, so that the data voltage is supplied to the end pixel electrodes R_{END}, G_{END}, and B_{END} through the first data line D1. In each of the end TFTs, a drain electrode is connected to a right extending line of the first data line D1, a source electrode is connected to the end pixel electrodes R_{END}, G_{END}, and B_{END} positioned at left side of the right extending line of the first data line D1, and a gate electrode is connected to even-numbered gate lines.

FIG. 3 is a waveform diagram illustrating an output of the source driver IC 12 of FIGS. 1 and 2.

As shown in FIG. 3, the source driver IC 12 outputs the data voltages of opposite polarities to the adjacent data lines and also allows a polarity of the data voltage supplied to each of the data lines D1 to Dm to remain in the same state during 1 frame period. In FIG. 3, “+” indicates a positive data voltage, and “−” indicates a negative data voltage.

The data voltage, to which subpixels of odd-numbered lines positioned along a first column (i.e., a leftmost column) of the pixel array 10 will be charged, is supplied to the first data line D1 during odd-numbered horizontal periods in each frame period. The gate pulse is supplied to the odd-numbered gate lines G1, G3, . . . during the odd-numbered horizontal periods in each frame period. As a result, liquid crystal cells of the subpixels of odd-numbered lines positioned along the first column of the pixel array 10 are charged to the data voltages of the first column supplied through the first data line D1 during the odd-numbered horizontal periods in each frame period.

The data voltage, to which subpixels of even-numbered lines positioned along an m-th column (i.e., a rightmost column) of the pixel array 10 will be charged, is supplied to the first data line D1 during even-numbered horizontal periods in each frame period. The gate pulse is supplied to the even-numbered gate lines G2, G4, . . . during the even-numbered horizontal periods in each frame period. In FIG. 3, R_{END}, G_{END}, and B_{END} indicate the data voltage supplied to the end pixel electrodes. As a result, liquid crystal cells of end subpixels positioned on the rightmost column of the pixel array 10 are charged to the data voltage supplied through the first data line D1 during the even-numbered horizontal periods in each frame period.

The timing controller 11 rearranges digital video data using a memory, so that the data voltage shown in FIG. 3 can be output from the source driver IC 12.

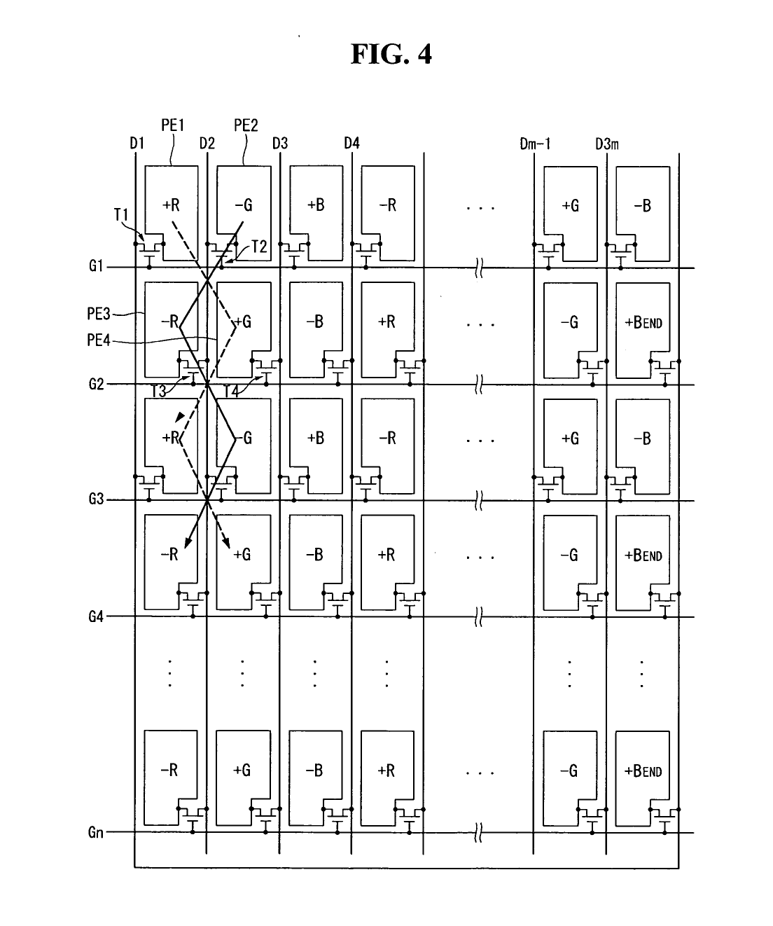

FIG. 4 is an equivalent circuit diagram illustrating a second embodiment of the pixel array 10.

As shown in FIG. 4, the pixel array 10 includes 3m data lines D1 to D3m and n gate lines G1 to Gn crossing each other at a resolution of m×n, a plurality of pixel electrodes PE1 to PE4 positioned in a matrix format, and a plurality of TFTs T1 to T4 respectively connected to the pixel electrodes PE1 to PE4. Liquid crystal cells of a red subpixel R are positioned on (3i+1)th columns of the pixel array 10. Liquid crystal cells of a green subpixel G are positioned on (3i+2)th columns of the pixel array 10. Liquid crystal cells of a blue subpixel B are positioned on (3i+3)th columns of the pixel array 10. Each of the TFTs T1 to T4 supplies the data voltage from the data lines D1 to D3m to the pixel electrodes PE1 to PE4 in response to a gate pulse from the gate lines G1 to Gn. The TFTs in each of the columns of the pixel array 10 are alternately connected to the two adjacent data lines at left and right sides of the TFTs in zigzag form. For example, in the TFTs between the adjacent data lines D1 and D2, the TFT T1 is connected to the right side of the data line D1, and the TFT T3 is connected to the left side of the data line D2. The data voltages of the same polarity and the data voltages of opposite polarities are supplied to adjacent liquid crystal cells in vertical and horizontal directions during 1 frame period as indicated by the dotted line and the solid line of FIG. 4 because of such an arrangement of the TFTs. Accordingly, a polarity pattern of the data voltages charged to the liquid crystal cells is implemented according to a dot inversion scheme.

The TFTs T1 and T2 for connecting the pixel electrodes PE1 and PE2 positioned at right side of each of the data lines D1 to D3m to the data lines D1 to D3m are positioned on odd-numbered lines LINE#1, LINE#3, . . . In the first TFT T1, a drain electrode is connected to the first data line D1, a source electrode is connected to the first pixel electrode PE1 positioned at right side of the first data line D1, and a gate electrode is connected to the first gate line G1. In the second TFT T2, a drain electrode is connected to the second data line D2, a source electrode is connected to the second pixel electrode PE2 positioned at right side of the second data line D2, and a gate electrode is connected to the first gate line G1.

Further, the TFTs T3 and T4 for connecting the pixel electrodes PE3 and PE4 positioned at left side of each of the data lines D2 to D3m to the data lines D2 to Dm are positioned on even-numbered lines L1NE#2, LINE#4, . . . In the third TFT T3, a drain electrode is connected to the second data line D2, a source electrode is connected to the third pixel electrode PE3 positioned at left side of the second data line D2, and a gate electrode is connected to the second gate line G2. In the fourth TFT T4, a drain electrode is connected to the third data line D3, a source electrode is connected to the fourth pixel electrode PE4 positioned at left side of the third data line D3, and a gate electrode is connected to the second gate line G2.

The end TFTs positioned at right end of the even-numbered lines LINE#2, LINE#4, . . . are connected to the first data line D1 and supply the data voltage supplied through the first data line D1 to end pixel electrodes R_{END}, G_{END}, and B_{END} positioned at right end of the even-numbered lines LINE#2, LINE#4, . . . . A data pad connected to the first data line D1 is connected to an output terminal of the source driver IC 12 in a left upper portion of the liquid crystal display panel. The first data line D1 extends from a left end of the pixel array 10 to a right end of the pixel array 10 across a lower portion of the liquid crystal display panel, so that the data voltage is supplied to the end pixel electrodes R_{END}, G_{END}, and B_{END} through the first data line D1. In each of the end TFTs, a drain electrode is connected to a right extending line of the first data line D1, a source electrode is connected to the end pixel electrodes R_{END}, G_{END}, and B_{END} positioned at left side of the right extending line of the first data line D1, and a gate electrode is connected to even-numbered gate lines.

FIG. 5 is a waveform diagram illustrating an output of the source driver IC of the liquid crystal display shown in FIGS. 1 and 3.

As shown in FIG. 5, the source driver IC 12 outputs the data voltages of opposite polarities to the adjacent data lines and also allows a polarity of the data voltage supplied to each of the data lines D1 to D3m to remain in the same state during 1 frame period. In FIG. 3, “+” indicates a positive data voltage, and “−” indicates a negative data voltage.

The data voltage, to which odd-numbered subpixels positioned along a first column (i.e., a leftmost column) of the pixel array 10 will be charged during odd-numbered horizontal periods, is supplied to the first data line D1 in each frame period. The gate pulse is supplied to the odd-numbered gate lines G1, G3, . . . during the odd-numbered horizontal periods in each frame period. As a result, liquid crystal cells of subpixels of odd-numbered lines positioned along the first column of the pixel array 10 are charged to the data voltages of the first column supplied through the first data line D1 during the odd-numbered horizontal periods in each frame period.

An end data voltage, to which even-numbered subpixels positioned along a 3m-th column (i.e., a rightmost column) of the pixel array 10 will be charged during even-numbered horizontal periods, is supplied to the first data line D1 in each frame period. The gate pulse is supplied to the even-numbered gate lines G2, G4, . . . during the even-numbered horizontal periods in each frame period. In FIG. 5, R_{END}, G_{END}, and B_{END} indicate the data voltage supplied to the end pixel electrodes. As a result, liquid crystal cells of end subpixels positioned on the rightmost column of the pixel array 10 are charged to the end data voltage supplied through the first data line D1 during the even-numbered horizontal periods in each frame period.

The timing controller 11 rearranges digital video data using a memory, so that the data voltage shown in FIG. 5 can be output from the source driver IC 12.

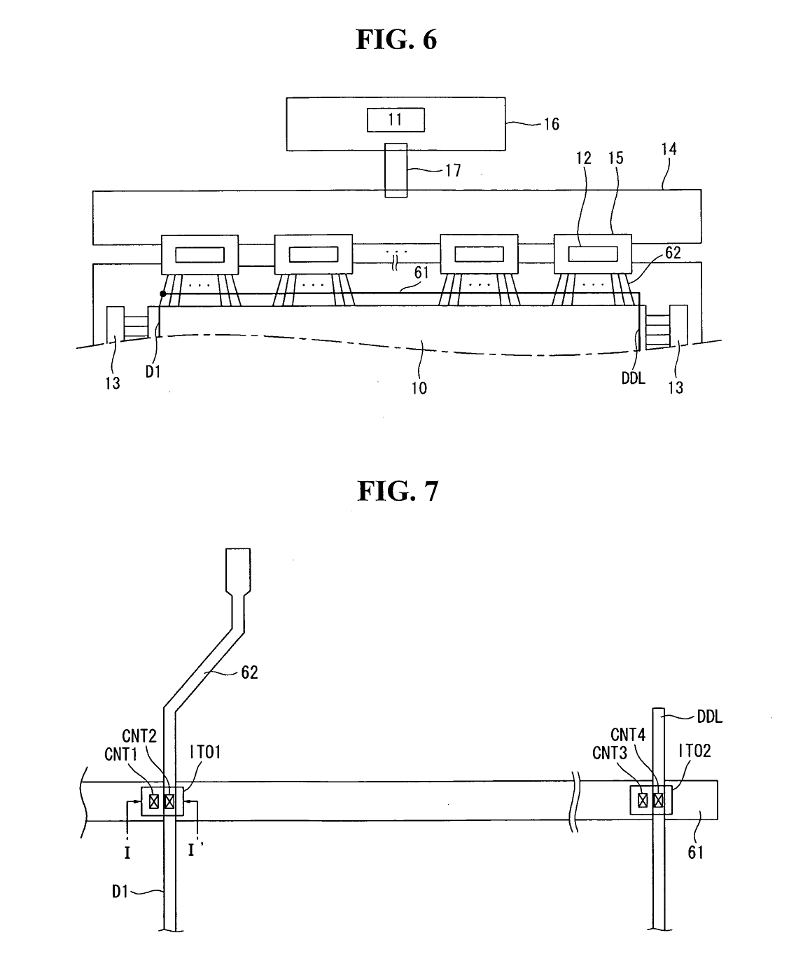

FIG. 6 is a block diagram illustrating a liquid crystal display according to a second embodiment of the invention.

As shown in FIG. 6, the liquid crystal display according to the second embodiment of the invention includes a connection line 61 connecting a first data line D1 to a dummy data line DDL across an upper portion of a liquid crystal display panel. Since the liquid crystal display according to the second embodiment of the invention except the connection line 61 is substantially the same as the liquid crystal display according to the first embodiment of the invention, a further description may be briefly made or may be entirely omitted. In the liquid crystal display according to the second embodiment of the invention, a pixel array 10 and a data voltage are substantially the same as FIGS. 2 to 4.

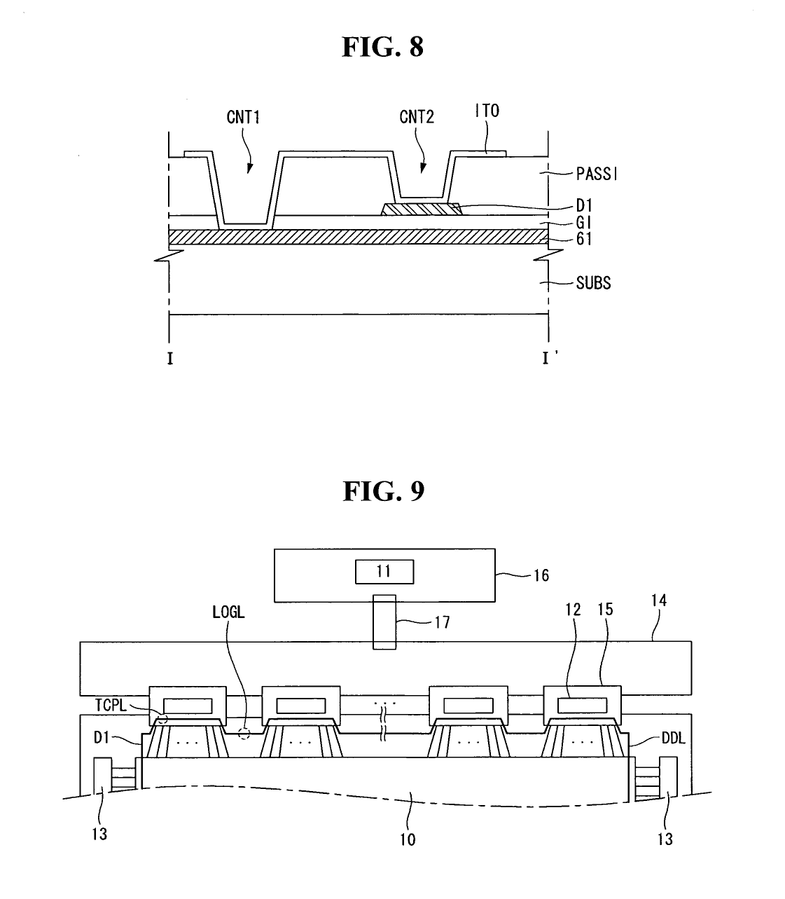

FIG. 7 is a plane view showing the first data line D1 and the dummy data line DDL connected through the connection line 61. FIG. 8 is a cross-sectional view showing a connection portion between the first data line D1 and the connection line 61 taken along line I-I′ of FIG. 7.

As shown in FIGS. 7 and 8, the connection line 61 connects the first data line D1 to the dummy data line DDL across the data lines or link lines 62 in the upper portion of the liquid crystal display panel. The dummy data line DDL is connected to the end TFTs positioned on a rightmost column of the pixel array 10 shown in FIGS. 2 and 4 and is not connected to an output channel of the source driver IC. The link lines 62 are metal lines respectively connecting the data lines to the output channels of the source driver ICs.

The connection line 61 is a gate metal pattern formed at the same time as the forming of the gate lines and the gate electrodes of the TFTs and is formed on the lower glass substrate of the liquid crystal display panel. A gate insulating layer GI deposited with an inorganic insulating material is formed on the connection line 61, and a semiconductor layer (not shown), a source metal (not shown), and a drain metal (not shown) are formed on the gate insulating layer GI. The source and drain metals are patterned through a photolithography process. As a result, the data lines, source electrodes and drain electrodes of the TFTs, and the link lines 62 are formed using the source and drain metals.

A passivation layer PASSI formed of an inorganic or organic insulating material is formed on the source and drain metals. First and second contact holes CNT1 and CNT2 are formed on the passivation layer PASSI through the photolithography process to expose a portion of the connection line 61 and a portion of the data line D1 (or a portion of the link line 62 connected to the data line D1). A transparent electrode material such as indium tin oxide (ITO) is deposited and patterned on the passivation layer PASSI. A first ITO pattern ITO1 is formed on the passivation layer PASSI to connect the connection line 61 to the first data line D1 through the first and second contact holes CNT1 and CNT2. The dummy data line DDL is connected to the connection line 61 through a second ITO pattern ITO2 according to the same connection structure as FIGS. 7 and 8.

FIG. 9 is a block diagram illustrating a liquid crystal display according to a third embodiment of the invention.

As shown in FIG. 9, the liquid crystal display according to the third embodiment of the invention includes a TCP line TCPL and a line-on-glass (LOG) line LOGL connecting a first data line D1 to a dummy data line DDL across an upper portion of a liquid crystal display panel. Since the liquid crystal display according to the third embodiment of the invention except the TCP line TCPL and the LOG line LOGL is substantially the same as the liquid crystal display according to the first and second embodiments of the invention, a further description may be briefly made or may be entirely omitted. In the liquid crystal display according to the third embodiment of the invention, a pixel array 10 and a data voltage are substantially the same as FIGS. 2 to 4.

The TCP line TCPL is formed on an upper surface or a lower surface of each TCP 15 on which each source driver IC 12 is mounted. The LOG line LOGL is directly formed on a lower glass substrate of the liquid crystal display panel. The TCP line TCPL and the LOG line LOGL connect in series the first data line D1 to the dummy data line DDL across the upper portion of the liquid crystal display panel in the same manner as the above embodiments. Accordingly, the data voltage supplied through the first data line D1 may be supplied to the end pixel electrodes of end subpixels positioned on a rightmost column of the pixel array 10 through the TCP line TCPL and the LOG line LOGL.

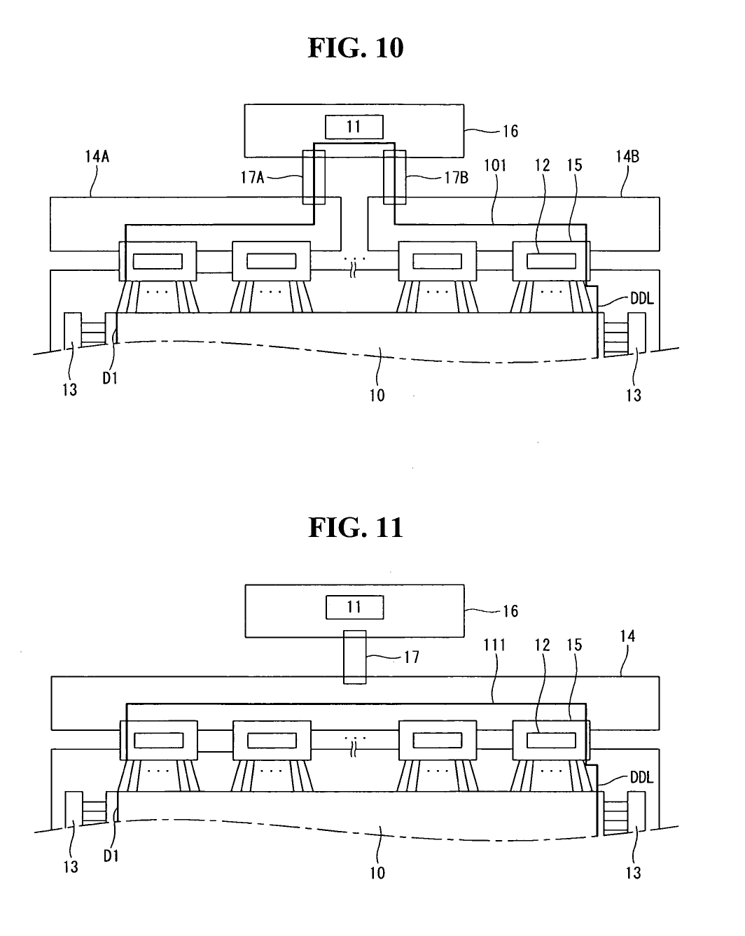

FIG. 10 is a block diagram illustrating a liquid crystal display according to a fourth embodiment of the invention.

As shown in FIG. 10, the liquid crystal display according to the fourth embodiment of the invention includes a connection line 101 passing through a left TCP 15, a first source PCB 14A, a first flexible circuit board 17A, a control PCB 16, a second flexible circuit board 17B, a second source PCB 14B, and a right TCP 15. Since the liquid crystal display according to the fourth embodiment of the invention except the connection line 101, a separation structure of the source PCB, and a separation structure of the flexible circuit board is substantially the same as the liquid crystal display according to the above embodiments of the invention, a further description may be briefly made or may be entirely omitted. In the liquid crystal display according to the fourth embodiment of the invention, a pixel array 10 and a data voltage are substantially the same as FIGS. 2 to 4.

The connection line 101 is a metal line connected to a data pad of a first data line D1 and an output channel of a first source driver IC 12 supplying the data voltage through the data pad. The connection line 101 connects in series the first data line D1 to a dummy data line DDL through the left TCP 15 attached to a left upper portion of the liquid crystal display panel, the first source PCB 14A, the first flexible circuit board 17A, the control PCB 16, the second flexible circuit board 17B, the second source PCB 14B, and the right TCP 15 attached to a right upper portion of the liquid crystal display panel. Accordingly, the data voltage supplied through the first data line D1 may be supplied to the end pixel electrodes of end subpixels positioned on a rightmost column of the pixel array through the connection line 101.

FIG. 11 is a block diagram illustrating a liquid crystal display according to a fifth embodiment of the invention.

As shown in FIG. 11, the liquid crystal display according to the fifth embodiment of the invention includes a connection line 111 passing through a TCP 12 and a source PCB 14. Since the liquid crystal display according to the fifth embodiment of the invention except the connection line 111 is substantially the same as the liquid crystal display according to the above embodiments of the invention, a further description may be briefly made or may be entirely omitted. In the liquid crystal display according to the fifth embodiment of the invention, a pixel array 10 and a data voltage are substantially the same as FIGS. 2 to 4. Each of the source PCB 14 and a flexible circuit board 17 may be divided into two parts.

The connection line 111 is a metal line connected to a data pad of a first data line D1 and an output channel of a first source driver IC 12 supplying the data voltage through the data pad. The connection line 111 connects in series the first data line D1 to a dummy data line DDL through a left TCP 15 attached to a left upper portion of a liquid crystal display panel, a source PCB 14, and a right TCP 15 attached to a right upper portion of the liquid crystal display panel. Accordingly, the data voltage supplied through the first data line D1 may be supplied to the end pixel electrodes of end subpixels positioned on a rightmost column of the pixel array through the connection line 111.

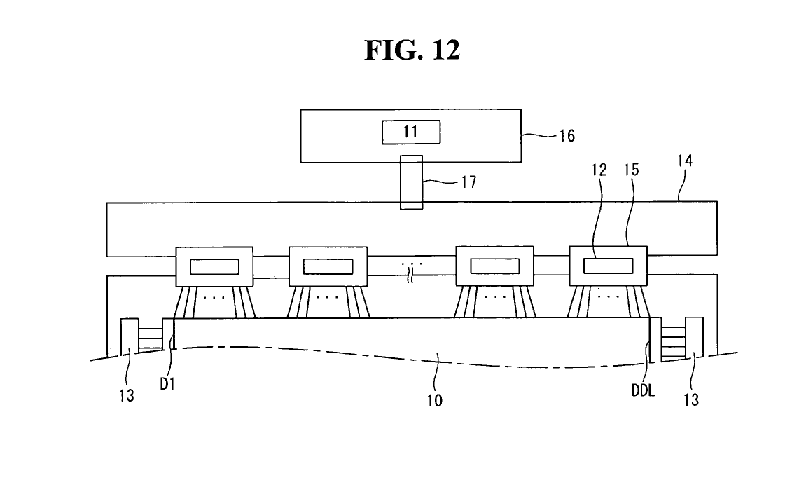

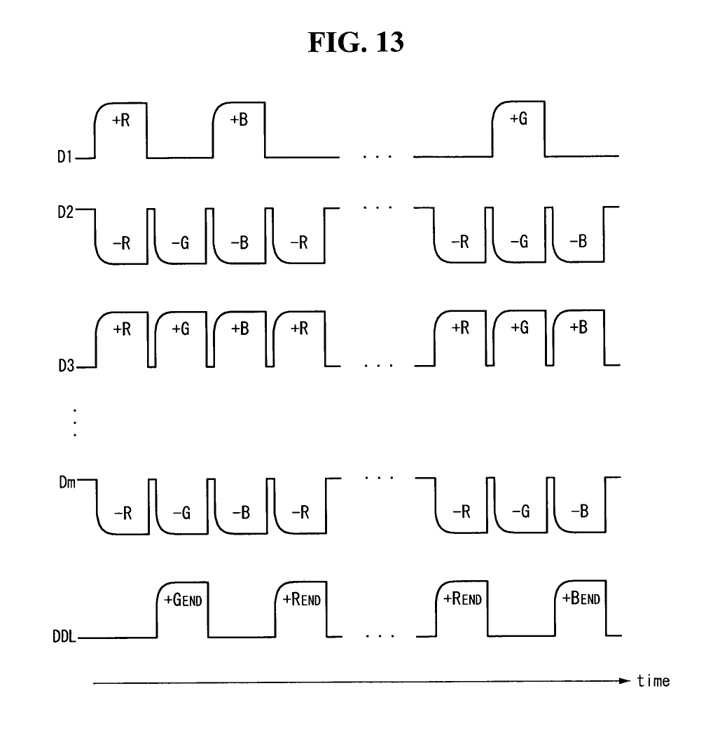

FIG. 12 is a block diagram illustrating a liquid crystal display according to a sixth embodiment of the invention. FIG. 13 is a waveform diagram showing a data voltage supplied to data lines of FIG. 12.

As shown in FIGS. 12 and 13, the liquid crystal display according to the sixth embodiment of the invention includes a dummy data line DDL formed at a right end of the pixel array 10 and source driver ICs 12 supplying the data voltage to the dummy data line DDL. Since the liquid crystal display according to the sixth embodiment of the invention except a connection structure between the dummy data line DDL and the source driver ICs 12 is substantially the same as the liquid crystal display according to the above embodiments of the invention, a further description may be briefly made or may be entirely omitted. In the liquid crystal display according to the sixth embodiment of the invention, a pixel array is substantially the same as FIGS. 2 to 4, except that a first data line D1 is not connected to the dummy data line DDL.

The source driver IC 12 positioned in a right upper portion of a liquid crystal display panel further includes an output channel connected to the dummy data line DDL. Accordingly, unlike the above embodiments, the dummy data line DDL directly receives the data voltage from the source driver IC 12 without being connected to the first data line D1.

The first data line D1 receives the data voltage, to which subpixels positioned on a leftmost column of the pixel array 10 will be charged, from the source driver IC 12 positioned in a left upper portion of the liquid crystal display panel during only odd-numbered horizontal periods in each frame period. On the other hand, the first data line D1 receives the data voltage, to which end subpixels positioned on a rightmost column of the pixel array 10 will be charged, from the source driver IC 12 positioned in the right upper portion of the liquid crystal display panel during only even-numbered horizontal periods in each frame period.

As described above, in the liquid crystal display according to the embodiments of the invention, the liquid crystal display panel can be driven in the dot inversion manner using the source driver IC outputting the data voltage whose a polarity is inverted in the column inversion manner. Furthermore, the data voltage can be stably supplied to the liquid crystal cells existing at the end of the liquid crystal display panel by adding the output channel to the source driver IC or by using the first data line.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A liquid crystal display comprising:
a liquid crystal display panel including a pixel array in which data lines and gate lines cross each other, liquid crystal cells are arranged in a matrix format according to a crossing structure of the data lines and the gate lines, and thin film transistors (TFTs) are alternately connected to data lines adjacent to the TFTs in zigzag form;
a plurality of source driver integrated circuits (ICs), each of which supplies a data voltage to the data lines; and
a gate drive circuit that sequentially supplies a gate pulse to the gate lines,
wherein the data voltage is supplied through a first data line positioned at an end of one side of the pixel array to liquid crystal cells positioned at an end of the other side of the pixel array.

2. The liquid crystal display of claim 1, wherein the first data line extends to the end of the other side of the pixel array across a lower portion of the liquid crystal display panel and is connected to TFTs of liquid crystal cells positioned at the end of the other side of the pixel array.

3. The liquid crystal display of claim 1, wherein the pixel array includes:
a second data line connected to TFTs of liquid crystal cells positioned at the end of the other side of the pixel array; and
a connection line that connects the first data line to the second data line.

4. The liquid crystal display of claim 3, wherein the connection line connects the first data line to the second data line across an upper portion or a lower portion of the liquid crystal display panel.

5. The liquid crystal display of claim 3, further comprising:
a plurality of tape carrier packages (TCPs) on which each of the source driver ICs is mounted;
a TCP line on at least one of the TCPs; and
a line-on-glass (LOG) line on a glass substrate of the liquid crystal display panel, the LOG line being connected in series to the TCP line,
wherein each of the TCP line and the LOG line connects the first data line to the second data line.

6. The liquid crystal display of claim 3, further comprising:
a plurality of TCPs on which each of the source driver ICs is mounted;
a source printed circuit board (PCB) connected to the TCPs;
a timing controller controlling the source driver ICs and the gate drive circuit;
a control PCB on which the timing controller is mounted;
a flexible circuit board connecting the source PCB to the control PCB ; and
a connection line that connects the first data line to the second data line through at least one of the TCPs, the source PCB, the flexible circuit board, and the control PCB.

7. The liquid crystal display of claim 3, further comprising:
a plurality of TCPs on which each of the source driver ICs is mounted;
a source PCB connected to the TCPs; and
a connection line that connects the first data line to the second data line through at least one of the TCPs and the source PCB.

8. The liquid crystal display of claim 3, wherein the second data line is not connected to the source driver ICs.

9. A liquid crystal display comprising:
a liquid crystal display panel including a pixel array in which data lines and gate lines cross each other, liquid crystal cells are arranged in a matrix format according to a crossing structure of the data lines and the gate lines, and thin film transistors (TFTs) are alternately connected to data lines adjacent to the TFTs in zigzag form;
a plurality of source driver integrated circuits (ICs), each of which supplies a data voltage to the data lines; and
a gate drive circuit that sequentially supplies a gate pulse to the gate lines,
wherein the data voltage output from a first source driver IC positioned at one side of the liquid crystal display panel is supplied to a first data line positioned at an end of one side of the pixel array,
wherein the data voltage output from a second source driver IC positioned at the other side of the liquid crystal display panel is supplied to a second data line positioned at an end of the other side of the pixel array.

10. The liquid crystal display of claim 9, wherein the first source driver IC supplies the data voltage to the first data line during odd-numbered horizontal periods in each frame period,
wherein the second source driver IC supplies the data voltage to the second data line during even-numbered horizontal periods in each frame period.
